(19) United States
(12) Patent Application Publication
(10) Pub. No.: US 2025/0388471 A1
(43) Pub. Date: Dec. 25, 2025

(54) CARBON MATERIAL DISPERSION AND USE THEREFOR

(71) Applicants: DAINICHISEIKA COLOR & CHEMICALS MFG. CO., LTD., Tokyo (JP); NANYANG TECHNOLOGICAL UNIVERSITY, Singapore (SG)

(72) Inventors: Hiroyuki SHIMANAKA, Tokyo (JP); Yoshikazu MURAKAMI, Tokyo (JP); Seiji DOI, Tokyo (JP); Risa SHITAOKA, Tokyo (JP); Daichi UMEDA, Tokyo (JP); Shota KANEKO, Tokyo (JP); Atsushi GOTO, Singapore (SG)

(21) Appl. No.: 18/879,458

(22) PCT Filed: Apr. 19, 2023
(86) PCT No.: PCT/JP2023/015566

§ 371 Date: Dec. 27, 2024

(30) Foreign Application Priority Data
Jul. 29, 2022 (JP) 2022-121689
Sep. 20, 2022 (JP) 2022-149305

(51) Int. Cl. C01B 32/174

(52) U.S. Cl. CPC C01B 32/174; C01B 2202/06; C01B 2202/22; C01B 2202/26; C01B 2202/34; C01B 2202/36; C01P 2006/40

(57) ABSTRACT

There is provided a carbon material dispersion wherein even when it contains a high concentration of a carbon material, the dispersibility of the carbon material is excellent and the dispersibility is retained stably over a long period of time. The carbon material dispersion contains: at least one carbon material selected from the group consisting of carbon black, carbon fibers, carbon nanotubes, graphite, and graphene; water; and a polymeric dispersant, wherein the polymeric dispersant is a polymer having carboxy groups at least part of which are neutralized with an alkali, the polymer having 50 to 80% by mass of a constituent unit (1) derived from (meth)acrylonitrile and 20 to 50% by mass of a constituent unit (2) derived from (meth)acrylic acid, provided that the total amount of the constituent unit (1) and the constituent unit (2) is 100% by mass, and the polymer has a number average molecular weight of 10,000 to 50,000.

### TECHNICAL FIELD

The present invention relates to a carbon material dispersion and use thereof.

### BACKGROUND ART

Carbon materials (nanocarbon materials) such as carbon black, a carbon fiber, a carbon nanotube, graphite, and graphene are materials that have a six-membered cyclic graphite structure formed of covalent bonds of carbon atoms and exhibit various properties such as electrical conductivity and heat transfer properties, and methods for utilizing the properties have been studied in a wide range of fields. For example, taking notice of the electrical characteristics, thermal characteristics, characteristics as a filler of carbon materials, the use of carbon materials for antistatic agents, electrically conductive materials, plastic reinforcing materials, semiconductors, fuel cell electrodes, cathode rays for displays, and the like has been studied.

For these applications, a carbon material dispersion wherein the dispersibility of a carbon material is good and the dispersibility is retained over a long period of time is required. However, nano-sized carbon materials have high surface energy and strong Van der Waals force acts thereon, and therefore nano-sized carbon materials are likely to aggregate. For this reason, a nano-sized carbon material, even when dispersed in a liquid medium, is likely to aggregate immediately in many cases.

General dispersants are used for stably dispersing a carbon material in a liquid medium. For example, there is disclosed a solvent-based dispersion of a carbon nanotube, in which a cationic surfactant, such as an alkanol amine salt, or a polymeric dispersant, such as a styrene-acrylic resin, is used (Patent Literatures 1 and 2).

### CITATION LIST

### Patent Literature

Patent Literature 1: Japanese Patent Laid-Open No. 2010-174084
Patent Literature 2: Japanese Translation of PCT International Application Publication No. 2013-537570

### SUMMARY OF INVENTION

### Technical Problem

When a surfactant is used as a dispersant, a carbon material such as a carbon nanotube can be dispersed in a liquid medium. However, the dispersibility of the carbon material in the resulting dispersion is not necessarily excellent, and furthermore, there is also a problem that the carbon material is likely to reaggregate. When a conventional polymeric dispersant is used, the resulting dispersion is likely to show thixotropic characteristics. For this reason, the carbon material may settle over time, or the dispersion may gel over time.

The present invention has been completed in view of such problems of the conventional techniques, and an object of the present invention is to provide a carbon material dispersion wherein even when it contains a high concentration of a carbon material, the dispersibility of the carbon material is excellent and the dispersibility is retained stably over a long period of time. Another object of the present invention is to provide use of this carbon material dispersion.

### Solution to Problem

Specifically, according to the present invention, there is provided a carbon material dispersion described below.
[1]A carbon material dispersion containing:
at least one carbon material selected from the group consisting of carbon black, carbon fibers, carbon nanotubes, graphite, and graphene;
water; and
a polymeric dispersant, wherein
the polymeric dispersant is a polymer having carboxy groups at least part of which are neutralized with an alkali, the polymer having 50 to 80% by mass of a constituent unit (1) derived from (meth)acrylonitrile and 20 to 50% by mass of a constituent unit (2) derived from (meth)acrylic acid, provided that the total amount of the constituent unit (1) and the constituent unit (2) is 100% by mass, and
the polymer has a number average molecular weight of 10,000 to 50,000.
[2] The carbon material dispersion according to [1], wherein
the polymer is an A-B block copolymer containing:
a polymer block A having 60 to 95% by mass of a constituent unit (1-A) derived from acrylonitrile and 5 to 40% by mass of a constituent unit (2-A) derived from methacrylic acid, provided that the total amount of the constituent unit (1-A) and the constituent unit (2-A) is 100% by mass; and
a polymer block B having 10 to 70% by mass of a constituent unit (1-B) derived from acrylonitrile and 30 to 90% by mass of a constituent unit (2-B) derived from methacrylic acid, provided that the total amount of the constituent unit (1-B) and the constituent unit (2-B) is 100% by mass, and
the polymer block A has a number average molecular weight of 8,000 to 40,000 and a polydispersity index of 1.8 or less.
[3] The carbon material dispersion according to [1] or [2], wherein
the alkali is at least one selected from the group consisting of lithium hydroxide, sodium hydroxide, and potassium hydroxide, and
the amount of the alkali corresponds to 50 to 120 mol % of the carboxy groups.
[4] The carbon material dispersion according to any one of [1] to [3], further containing at least one water-soluble organic solvent selected from the group consisting of dimethylformamide, dimethylacetamide, diethylacetamide, N-methylpyrrolidone, 3-methoxy-N,N-dimethylpropanamide, 3-butoxy-N,N-dimethylpropanamide, tetramethyl urea, 1,3-dimethylimidazolidinone, and acetonitrile.
[5] The carbon material dispersion according to any one of [1] to [4], wherein
the content of the polymeric dispersant based on 100 parts by mass of the carbon material is 10 to 350 parts by mass, and
the content of the carbon material is 15% by mass or less.
[6] The carbon material dispersion according to any one of [1] to [5], further containing a binder resin.

In addition, according to the present invention, there is provided use of the carbon material dispersion, described below.
[7] Use of the carbon material dispersion according to any one of [1] to [6] for producing any one of the products of paints, inks, coating agents, materials for resin shaped articles, electrically conductive materials, thermally conductive materials, and antistatic materials.
[8] Use of the carbon material dispersion according to any one of [1] to [6] for producing any one of the products of battery materials and mechanical components each comprising a film formed with the carbon material dispersion.

### Advantageous Effects of Invention

The present invention makes it possible to provide a carbon material dispersion wherein even when it contains a high concentration of a carbon material, the dispersibility of the carbon material is excellent and the dispersibility is retained stably over a long period of time. In addition, the present invention makes it possible to provide use of this carbon material dispersion.

The carbon material dispersion of the present invention is excellent in dispersibility, storage stability, viscosity properties, and processability, and a carbon coating film can be formed easily by, for example, applying the carbon material dispersion of the present invention. In addition, it is also expected that a highly transparent film can be formed by appropriately selecting a carbon material. Furthermore, a carbon material is dispersed in good condition even when the content of a polymeric dispersant is small, and therefore a coating film containing a large amount of the carbon material can be formed, and it is also expected that the properties of a carbon material itself, such as electrical conductivity and thermal conductivity, can be utilized.

### DESCRIPTION OF EMBODIMENTS

### <Carbon Material Dispersion>

Hereinafter, embodiments of the present invention will be described, but the present invention is not limited to the following embodiments. One embodiment of a carbon material dispersion of the present invention is an aqueous carbon material dispersion containing a carbon material, water, and a polymeric dispersant. Hereinafter, details on the carbon material dispersion of the present invention will be described.

### (Carbon Material)

The carbon material is at least one selected from the group consisting of carbon black, carbon fibers, carbon nanotubes, graphite, and graphene. Examples of carbon black include acetylene black, furnace black, thermal black, and Ketjen black.

As the carbon nanotube, a multi-walled carbon nanotube that has multi-layers and a single-walled carbon nanotube that has a single layer can be used. The average length of the multi-walled carbon nanotube is preferably 40 to 3,000 μm. The average length of the single-walled carbon nanotube is preferably 5 to 600 μm.

Examples of the carbon fiber include PAN-based carbon fibers using polyacrylonitrile as a raw material, pitch-based carbon fibers using pitch or the like as a raw material, and recycled products thereof. Among others, a so-called carbon nanofiber, which has a nanosized fiber diameter and has a cylindrical shape obtained by winding six-membered cyclic graphite structures, or a carbon nanotube having a single-digit-nanosized diameter is preferable. The carbon nanofiber and the carbon nanotube may be any of multi-layered carbon nanofibers and single-layered carbon nanofibers, and any of multi-walled carbon nanotubes and single-layered carbon nanotubes, respectively.

Graphite is a layered substance containing hexagonal plate-like crystals composed of carbon. Among others, graphene formed of a single layer having a thickness corresponding to one atom, obtained by peeling of graphite, and graphene formed of multi-layers can be used.

In the carbon material, a metal, such as platinum and palladium, or a metal salt may be doped. In addition, the carbon material may be surface-modified by oxidation treatment, plasma treatment, radiation treatment, corona treatment, coupling treatment, or the like.

### (Polymeric Dispersant)

The polymeric dispersant (hereinafter, also simply referred to as “dispersant”) is a component for dispersing the carbon material in a dispersion medium (liquid medium) containing water and is a polymer having carboxy groups at least part of which are neutralized with an alkali. More specifically, the polymeric dispersant is a polymer having a constituent unit (1) derived from (meth)acrylonitrile and a constituent unit (2) derived from (meth)acrylic acid, and the polymeric dispersant is preferably a polymer substantially consisting of a constituent unit (1) derived from (meth)acrylonitrile and a constituent unit (2) derived from (meth)acrylic acid.

The constituent unit (1) has a cyano group (—CN) derived from (meth)acrylonitrile. For this reason, the triple bond of the cyano group acts on the surface of the carbon material, so that the polymer which is the dispersant is electronically adsorbed onto the carbon material. The constituent unit (2) has a carboxy group derived from (meth)acrylic acid. For this reason, the polymer which is the dispersant can be dissolved into the liquid medium containing water by neutralizing and ionizing at least part of the carboxy groups with an alkali. The use of the polymer containing these constituent unit (1) and constituent unit (2) as the dispersant makes it possible to disperse the carbon material finely in the liquid medium containing water over a long period of time.

The proportion of the constituent unit (1) derived from (meth)acrylonitrile in the polymer is 50 to 80% by mass, preferably 55 to 75% by mass. The proportion of the constituent unit (2) derived from (meth)acrylic acid in the polymer is 20 to 50% by mass, preferably 25 to 45% by mass. Note that the total amount of the constituent unit (1) and the constituent unit (2) is 100% by mass. When the proportion of the constituent unit (2) in the polymer is less than 20% by mass, the water-solubility of the polymer is deficient. On the other hand, when the proportion of the constituent unit (2) in the polymer is more than 50% by mass, the water-solubility of the polymer is excessively high. This makes the viscosity of the carbon material dispersion excessively high and may lower the water resistance of a coating film to be formed because the amount of the hydrophilic carboxy groups is large.

The polymeric dispersant (polymer) may further have an additional constituent unit other than the constituent unit (1) and the constituent unit (2). Examples of monomers for forming the additional constituent unit include conventionally known styrene-based monomers and (meth)acrylate-based monomers. Among others, a monomer free of an easily hydrolyzable structure, such as an ester bond and an amide bond, is preferably used. Examples of such a monomer include styrene, vinyl naphthalene, vinyltoluene, vinylbiphenyl, and vinyl alcohol.

The number average molecular weight of the polymer which is used as the polymeric dispersant is 10,000 to 50,000, preferably 12,000 to 45,000. When the number average molecular weight of the polymer is lower than 10,000, the polymer is likely to be desorbed after it is adsorbed onto the carbon material, which may make it difficult to improve the dispersion stability. On the other hand, when the number average molecular weight of the polymer is higher than 50,000, the viscosity may be excessively high. The number average molecular weight herein is a value in terms of polystyrene or polymethyl methacrylate, as measured by gel permeation chromatography using N,N-dimethylformamide as a developing solvent.

The polymer which is the polymeric dispersant is preferably an A-B block copolymer containing: a polymer block A having a constituent unit (1-A) derived from acrylonitrile and a constituent unit (2-A) derived from methacrylic acid; and a polymer block B having a constituent unit (1-B) derived from acrylonitrile and constituent unit (2-B) derived from methacrylic acid. Note that the polymer block A is preferably a polymer block substantially consisting of a constituent unit (1-A) derived from acrylonitrile and a constituent unit (2-A) derived from methacrylic acid. In addition, the polymer block B is preferably a polymer block substantially consisting of a constituent unit (1-B) derived from acrylonitrile and a constituent unit (2-B) derived from methacrylic acid.

The proportion of the constituent unit (1-A) derived from acrylonitrile in the polymer block A (hereinafter, also referred to as “chain A”) is preferably 60 to 95% by mass, more preferably 65 to 90% by mass. The proportion of the constituent unit (2-A) derived from methacrylic acid in the chain A is preferably 5 to 40% by mass, more preferably 10 to 35% by mass. Note that the total amount of the constituent unit (1-A) and the constituent unit (2-A) is 100% by mass.

The content of the carboxy groups is smaller in the chain A than in the polymer block B (hereinafter, also referred to as “chain B”), and therefore the chain A is a polymer block having relatively lower water-solubility than the chain B. For this reason, the chain A adsorbed onto the carbon material is more unlikely to be desorbed than the chain B and therefore has a function of improving the dispersibility of the carbon material more. When the proportion of the constituent unit (2-A) in the chain A is less than 5% by mass, the water-solubility of the chain A may be deficient. On the other hand, when the proportion of the constituent unit (2-A) in the chain A is more than 40% by mass, the water-solubility of the chain A may be too high and therefore may be more likely to be desorbed from the carbon material.

The number average molecular weight of the polymer block A (chain A) is preferably 8,000 to 40,000, more preferably 10,000 to 35,000. When the number average molecular weight of the chain A is lower than 8,000, the adsorption onto the carbon material may be deficient. On the other hand, when the number average molecular weight of the chain A is higher than 40,000, the water-solubility may be insufficient even if the chain A has the constituent unit (2-A) having a carboxy group.

The polydispersity index (PDI=weight average molecular weight (Mw)/number average molecular weight (Mn)) of the polymer block A (chain A) is preferably 1.8 or less, more preferably 1.6 or less. When the molecular weights are relatively uniform, thereby the polymer block A can be adsorbed onto the carbon material more uniformly, and the dispersibility can be improved further. When the polydispersity index (PDI value) of the chain A is more than 1.8, a large amount of polymer blocks having a number average molecular weight out of the above-described range are contained, so that the effect of improving the dispersibility may be lowered.

The proportion of the constituent unit (1-B) derived from acrylonitrile in the polymer block B (chain B) is preferably 10 to 70% by mass, more preferably 15 to 65% by mass. The proportion of the constituent unit (2-B) derived from methacrylic acid in the chain B is preferably 30 to 90% by mass, more preferably 35 to 85% by mass. Note that the total amount of the constituent unit (1-B) and the constituent unit (2-B) is 100% by mass.

The chain B is a polymer block containing a larger amount of carboxy groups than the chain A and having relatively higher water-solubility than the chain A. When the proportion of the constituent unit (2-B) in the chain B is less than 30% by mass, the water-solubility of the A-B block copolymer as a whole may be deficient. On the other hand, when the proportion of the constituent unit (2-B) in the chain B is more than 90% by mass, the affinity to water may be excessively high. For this reason, the viscosity of the carbon material dispersion may be excessively high, and the water resistance of a coating film to be formed may be lowered.

The A-B block copolymer can be produced by, for example, a living radical polymerization method. Note that the A-B block copolymer is formed with acrylonitrile and methacrylic acid, and therefore it is easy to control the structure thereof, and it is also easy to adjust the molecular weight.

As the alkali for neutralizing at least part of the carboxy groups in the polymeric dispersant (polymer), conventionally known alkalis including, for example, ammonia; organic amines, such as triethylamine and dimethylaminoethanol; and alkali metal hydroxides, such as lithium hydroxide, sodium hydroxide, and potassium hydroxide, can be used. Among others, the alkali is preferably at least one selected from the group consisting of lithium hydroxide, sodium hydroxide, and potassium hydroxide from the viewpoint of, for example, improving water-solubility, and improving electrical conductivity of a coating film by the action of ions.

All of the carboxy groups in the polymer may be neutralized with the alkali, but it is also preferable to neutralize only part of the carboxy groups with the alkali within a range where the polymer can be dissolved in water. The carboxy groups (—COOH) not neutralized by the alkali can form hydrogen bonds with the carbon material. For this reason, when the polymer in which only part of the carboxy groups are neutralized with the alkali is used as a dispersant, the dispersion stability of the carbon material dispersion can be improved further. The amount of the alkali for neutralizing the carboxy groups is preferably an amount corresponding to 50 to 120 mol % of the carboxy groups, more preferably an amount corresponding to 70 to 110 mol % of the carboxy groups.

The polymer which is used as a polymeric dispersant can be produced by a conventionally known method. The polymer can be produced by, among others, a solution polymerization method using an organic solvent; a radical polymerization method using an azo-based radical generator or a peroxide radical generator; and other methods. As the organic solvent, a conventionally known organic solvent can be used. However, the polymer may be difficult to dissolve in a general-purpose organic solvent, and therefore a water-soluble polar organic solvent is preferably used. Examples of such a polar organic solvent include an amide-based solvent, a sulfoxide-based solvent, a urea-based solvent, and nitrile-based solvent. It is preferable to use, among others, an amide-based solvent, a urea-based solvent, and a nitrile-based solvent. After the polymerization is performed in any of these organic solvents, an aqueous alkali solution is added to the polymerization solution to neutralize the carboxy groups and form an aqueous solution, and thereby a carbon material dispersion containing the organic solvent can be obtained.

Examples of the amide-based solvent include dimethylformamide, dimethylacetamide, diethylacetamide, N-methylpyrrolidone, 3-methoxy-N,N-dimethylpropanamide, and 3-butoxy-N,N-dimethylpropanamide. Examples of the urea-based solvent include tetramethyl urea and 1,3-dimethylimidazolidinone. Examples of the nitrile-based solvents include acetonitrile.

It is difficult to produce the A-B block copolymer which is used as a polymeric dispersant by an ordinary radical polymerization method. For this reason, the A-B block copolymer is preferably produced by a living polymerization method, such as a living anionic polymerization method, a living cationic polymerization method, and a living radical polymerization method. Among others, a living radical polymerization method is particularly preferable from the viewpoint of conditions, materials, apparatus, and the like.

Examples of the living radical polymerization method include an Atom Transfer Radical Polymerization method (ATRP method), a Reversible Addition-Fragmentation Chain Transfer Polymerization method (RAFT method), a Nitroxide-Mediated Polymerization method (NMP method), an Organotellurium-Mediated Living Radical Polymerization method (TERP method), a Reversible Chain Transfer Catalyzed Polymerization method (RTCP method), and a Reversible Complexation Mediated Polymerization method (RCMP method). Among others, the RTCP method and the RCMP method, in which an organic compound is used as a catalyst, and an organic iodide is used as a polymerization initiation compound, are preferable. These methods are advantageous in terms of costs and purification because a commercially available compound which is relatively safe is used, and a heavy metal and a special compound are not used. Furthermore, by using tertiary iodine as a growth terminal, block structures can be easily formed with good precision using general facilities.

In producing the A-B block copolymer, any of the polymerization for forming the polymer block A and the polymerization for forming the polymer block B may be performed first. However, when the polymerization for forming the polymer block B is performed first, methacrylic acid may remain in the polymerization system. In this case, a constituent unit derived from methacrylic acid may be introduced excessively into the polymer block A which is formed later. For this reason, the polymerization for forming the polymer block B is preferably performed after the polymerization for forming the polymer block A is first performed.

### (Liquid Medium)

The carbon material dispersion of the present embodiment contains water as a dispersion medium (liquid medium) for dispersing the carbon material. In other words, the carbon material dispersion of the present embodiment is an aqueous dispersion. In the dispersion medium, a liquid medium other than water may be contained as necessary. As the liquid medium other than water, a water-soluble organic solvent can be used.

Examples of the water-soluble organic solvent include: alcohols, such as methanol, ethanol, and isopropyl alcohol; polyhydric alcohols, such as ethylene glycol, propylene glycol, and glycerol; ethers, such as tetrahydrofuran; glycol ethers, such as diethylene glycol, triethylene glycol, diethylene glycol monomethyl ether, diethylene glycol monobutyl ether, ethylene glycol dimethyl ether, propylene glycol monomethyl ether, propylene glycol monoethyl ether, propylene glycol monopropyl ether, dipropylene glycol monomethyl ether, and tripropylene glycol monomethyl ether; glycol ether esters, such as diethylene glycol monomethyl ether acetate; amides, such as pyrrolidone, N-methylpyrrolidone, dimethylformamide, dimethylacetamide, 3-methoxy-N,N-dimethylpropanamide, and 3-butoxy-N,N-dimethylpropanamide; urea-based solvents, such as tetramethyl urea and 1,3-dimethylimidazolidinone; sulfur-containing solvents, such as dimethyl sulfoxide and sulfolane; and ionic liquids, such as 1-ethyl-3-methyl imidazolium chloride.

Especially, a solvent used in performing polymerization for forming the polymeric dispersant is preferably contained as it is as a liquid medium in the carbon material dispersion of the present embodiment. Specifically, the carbon material dispersion of the present embodiment preferably further contains at least one water-soluble organic solvent selected from the group consisting of dimethylformamide, dimethylacetamide, diethylacetamide, N-methylpyrrolidone, 3-methoxy-N,N-dimethylpropanamide, 3-butoxy-N,N-dimethylpropanamide, tetramethyl urea, 1,3-dimethylimidazolidinone, and acetonitrile. The use of any of these water-soluble organic solvents makes it possible to improve the wettability of the carbon material to the dispersion medium. Furthermore, the leveling performance of a coating film to be formed can be improved, and a function such as dryness prevention performance can be imparted to a coating film to be formed.

The content of the water-soluble organic solvent in the carbon material dispersion is preferably set to 20% by mass or less, more preferably 10% by mass or less.

### (Carbon Material Dispersion)

The content of the polymeric dispersant in the carbon material dispersion is preferably 10 to 350 parts by mass, more preferably 20 to 300 parts by mass, particularly preferably 30 to 250 parts by mass, based on 100 parts by mass of the carbon material. The content of the carbon material in the carbon material dispersion is preferably 15% by mass or less. By setting the content of the polymeric dispersant based on the amount of the carbon material within the above ranges, a carbon material dispersion in which the carbon material is more stably dispersed can be prepared. When the amount of the polymeric dispersant is excessively small based on the amount of the carbon material, the dispersibility may be somewhat insufficient. On the other hand, when the amount of the polymeric dispersant based on the amount of the carbon material is excessively large, the viscosity of the carbon material dispersion may be likely to increase, and the ratio of the carbon material in the solid content may be relatively lowered.

The carbon material dispersion preferably further contains a binder resin. When the binder resin (hereinafter, also referred to as “binder”) is contained, thereby an electrically conductive coating film having excellent properties such as stretching and bending and having further improved adhesion to a substrate or the like can be formed. As the binder resin, cellulose derivatives such as carboxymethyl cellulose (including Na salt); styrene/butadiene copolymers; and acrylic resins such as styrene/acrylic resins are preferably used taking, for example, the affinity to the polymeric dispersant into consideration.

When the carbon material dispersion is used as a material for forming a coating film or used as a paint, the content of the binder resin in the carbon material dispersion is preferably 0.3 to 200 parts by mass, more preferably 3 to 100 parts by mass, based on 1 part by mass of the carbon material. When the amount of the binder resin is too small, coating of a substrate may be somewhat difficult, and the uniformity of a coating film may be deficient. On the other hand, when the amount of the binder resin is too large, the amount of the carbon material is relatively lowered, and therefore the electrical conductivity of a coating film to be formed may be somewhat insufficient.

When the carbon material dispersion is used as a material for forming a film of an electrode that is a battery material, the content of the binder resin in the carbon material dispersion is preferably 0.5 to 500 parts by mass, more preferably 5 to 300 parts by mass, based on 1 part by mass of the carbon material. When the amount of the binder resin is too small, coating of a substrate may be somewhat difficult, and a uniform electrode may be difficult to obtain. On the other hand, when the amount of the binder resin is too large, the amount of the carbon material that functions as an active material is relatively lowered, and therefore the capacity of a battery to be obtained may be insufficient.

The carbon material dispersion can further contain an additive, a resin, and the like. Examples of the additive include a water-soluble dye, a pigment, an ultraviolet absorber, a light stabilizer, an antioxidant, a levelling agent, a defoamer, an antiseptic, a mildew-proofing agent, a photopolymerization initiator, and other pigment dispersants. Examples of the resin include a polyolefin resin, a polyhalogenated olefin resin, a polyester resin, a polyamide resin, a polyimide resin, a polyether resin, a polyvinyl resin, a polystyrene resin, a polyvinyl alcohol resin, a polymethacrylate resin, a polyurethane resin, a polyepoxy resin, a polyphenol resin, a polyurea resin, and a polyethersulfone resin.

### (Method for Producing Carbon Material Dispersion)

The carbon material dispersion of the present embodiment can be prepared by using the above-described polymer as the polymeric dispersant and dispersing the carbon material according to a conventionally known method in a dispersion medium (liquid medium) containing water as a main component. For example, a dispersion method such as stirring with a disper, kneading with a three-roll mill, ultrasonic dispersion, dispersion with a bead mill, and dispersion using an emulsifying apparatus, a high-pressure homogenizer, or the like can be used. Among others, dispersion with a bead mill, ultrasonic dispersion, and dispersion using a high pressure homogenizer are preferable because of a high dispersion effect.

### (Method for Checking Dispersion State of Carbon Material)

The dispersibility of the carbon material in the carbon material dispersion can be checked by a method of measuring the absorbance using a spectrophotometer, as described below. First, a plurality of extremely low-concentration dispersions in which the carbon material concentration is known is prepared, and the absorbance of each dispersion at a particular wavelength is measured to make a calibration curve by plotting the absorbance against the concentration of the carbon material. The carbon material dispersion is subjected to centrifugal separation treatment to separate the carbon material not dispersed by sedimentation and obtain a supernatant. The obtained supernatant is diluted to a concentration where the absorbance can be measured, and the absorbance is measured to calculate the concentration of the carbon material from the calibration curve. The dispersibility of the carbon material can be evaluated by comparing the calculated concentration of the carbon material and the amount of carbon material charged.

In addition, the dispersibility of the carbon material can also be checked by leaving the carbon material dispersion after the centrifugal separation treatment to stand still for a long period of time and then checking whether an aggregate is present or not. Furthermore, the dispersibility of the carbon material can also be checked by observing the state of the carbon material dispersion dropped onto a glass plate or the like using an electron microscope or the like, or by measuring a physical property value such as electrical conductivity of a film formed by applying and drying the carbon material dispersion.

### <Use of Carbon Material Dispersion>

The carbon material dispersion of the present embodiment is a water-based dispersion and therefore is an environmentally friendly material and useful as a material for producing a paint, an ink, a coating agent, a material for a resin shaped article, and the like. Moreover, utilization of the carbon material dispersion of the present embodiment as an electrically conductive material or a thermally conductive material can be expected, and besides, the application to antistatic materials can also be expected. Furthermore, the carbon material dispersion of the present embodiment is useful as a material for forming a film that forms battery materials or capacitor materials, such as an electrode material for forming a battery such as a lithium ion battery or a fuel cell. The carbon material dispersion of the present embodiment is also useful as a material for forming a film that forms various mechanical components.

An aqueous paint or ink can be prepared by, for example, adding various components, such as a solvent, a resin, and an additive, to the carbon material dispersion. The carbon material dispersion may be added to a commercially available paint or ink.

A resin shaped article can be produced by, for example, adding the carbon material dispersion to a molten plastic material and then removing water. A resin shaped article in which the carbon material is dispersed can also be produced by adding the carbon material dispersion to a fine powder of a plastic material and then removing water or precipitating the carbon material.

### EXAMPLES

Hereinafter, the present invention will be specifically described based on Examples, but the present invention is not limited to these Examples. Note that the “part(s)” and “%” in Examples and Comparative Examples are each on a mass basis unless otherwise noted.

### <Synthesis of Polymeric Dispersant (Polymer)>

### Synthesis Example 1

In a reaction container, 233.3 parts of N-methylpyrrolidone (NMP) was placed and stirred, and the temperature was increased to 70° C. In a beaker, 70 parts of acrylonitrile (AN), 30 parts of acrylic acid (AA), and 5.0 parts of 2,2′-azobis(2,4-dimethylvaleronitrile) (trade name “V-65,” manufactured by FUJIFILM Wako Pure Chemical Corporation) (V-65) were placed, and V-65 was completely dissolved to prepare a monomer solution. The prepared monomer solution was placed in a dropping funnel, and when the temperature in the reaction container reached 70° C., ⅓ of the total amount was put into the reaction container, and the remaining solution was dropped over 1.5 hours. V-65 in an amount of 1.0 part was added 2.5 hours after completion of the dropping. After the temperature of the resulting mixture was kept at 70° C. for 1 hour, the temperature was increased to 80° C. and kept there for 2 hours to form a polymer. After the reaction solution was cooled, the solid content was measured using a moisture meter to ascertain that almost all the monomers were consumed. The number average molecular weight (Mn) in terms of polymethyl methacrylate and polydispersity index (PDI=weight average molecular weight (Mw)/number average molecular weight (Mn)) of the polymer were 14,400 and 2.85 respectively, as measured by gel permeation chromatography (GPC) using an N,N-dimethylformamide solution of lithium bromide (concentration of lithium bromide: 10 mmol/L) as a developing solvent.

In a beaker, 18.3 parts (110 mol % based on AA) of sodium hydroxide (NaOH) and 83.2 parts of ion-exchanged water were placed, and NaOH was completely dissolved to prepare an aqueous NaOH solution. After the temperature in the reaction container became 60° C. or lower, the aqueous NaOH solution was put into the reaction container to neutralize carboxy groups, and thus polymeric dispersant solution AA-1 was obtained. The solid content of polymeric dispersant solution AA-1 obtained was 23.2%.

### Synthesis Examples 2 and 3

Polymeric dispersant solutions AA-2 and AA-3 were obtained in the same manner as in Synthesis Example 1 except that the compositions shown in Table 1 were adopted. Physical properties of polymeric dispersant solutions AA-2 and AA-3 obtained are shown in Table 1. The meanings of the abbreviations in Table 1 are described below.
MAN: methacrylonitrile
MAA: methacrylic acid
DMF: N,N-dimethylformamide

TABLE 1
Compositions and physical properties of polymers
obtained in Synthesis Examples 1 to 3

| | | Synthesis | Synthesis | Synthesis |
|---|---|---|---|---|
| | | Example 1 | Example 2 | Example 3 |
| Polymeric dispersant solution | | AA-1 | AA-2 | AA-3 |
| Solvent | NMP | 233.3 | 233.3 | — |
| | DMF | — | — | 233.3 |
| Monomer | AN | 70.0 | 60.0 | — |
| | MAN | — | — | 75.0 |
| | AA | 30.0 | 40.0 | — |
| | MAA | — | — | 25.0 |
| Polymerization | V-65 | 5.0 | 3.0 | 1.5 |
| initiator | V-65 | 1.0 | 1.0 | 1.0 |
| | (added later) | | | |
| Aqueous alkali | NaOH | 18.3 (110 | 24.4 (110 | — |
| solution | | mol % | mol % | |
| | | neutralization) | neutralization) | |
| | KOH | — | — | 16.3 (110 |
| | | | | mol % |
| | | | | neutralization) |
| | Ion-exchanged water | 83.2 | 96.8 | 50.4 |
| Whole | Mn | 14,400 | 25,300 | 44,300 |
| | PDI | 2.85 | 2.24 | 2.56 |
| | Composition | AN/AA | AN/AA | MAN/MAA |
| | Composition ratio | 70/30 | 60/40 | 75/25 |
| | (mass ratio) | | | |
| | Solid content (%) | 23.2 | 22.1 | 25.6 |

### Synthesis Example 4

In a reaction container, 255.4 parts of 3-methoxy-N,N-dimethylpropanamide (MDMPA), 1.0 part of iodine, 3.7 parts of 2,2′-azobis(4-methoxy-2,4-dimethylvaleronitrile) (trade name “V-70,” manufactured by FUJIFILM Wako Pure Chemical Corporation) (V-70), 0.2 parts of diphenylmethane (DPM), 106.1 parts of AN, and 26.5 parts of MAA were placed. The resulting mixture was stirred in a nitrogen gas stream, the temperature was increased to 40° C. to perform polymerization for 4 hours, and thus a chain A was formed. The solid content of the reaction solution was 34.8%, and the conversion rate of the polymerization calculated from the solid content was about 100%. Mn, PDI, and peak top molecular weight (PT) of the formed chain A were 14,800, 1.41, and 20,700, respectively.

After 3.1 parts of V-70 was added, a monomer solution containing 30.0 parts of AN, 31.8 part of MAA, and 216.9 parts of MDMPA was further added. Thereafter, polymerization was performed at 40° C. for 4 hours to form a chain B, and thus an A-B block copolymer was obtained. The solid content of the reaction solution was 29.9%, and thereby it was ascertained that a target product was obtained almost quantitatively. Mn, PDI, and PT of the obtained A-B block copolymer were 21,600, 1.52, and 32,700, respectively. The molecular weight of the chain B can be calculated by subtracting Mn of the chain A from Mn of the A-B block copolymer. Specifically, Mn and PT of the chain B were 6,800 and 12,000, respectively.

In a beaker, 29.8 parts (110 mol % based on MAA) of NaOH and 105.1 parts of ion-exchanged water were placed, and NaOH was completely dissolved to prepare an aqueous NaOH solution. The aqueous NaOH solution was put into the reaction container to neutralize carboxy groups, and thus polymeric dispersant solution AB-1 was obtained. The solid content of polymeric dispersant solution AB-1 obtained was 25.1%.

### Synthesis Examples 5 to 8

Polymeric dispersant solutions AB-2 to 5 were obtained in the same manner as in Synthesis Example 4 except that the compositions shown in Table 2 were adopted. Physical properties of polymeric dispersant solutions AB-1 to 5 obtained are shown in Table 2. The meanings of the abbreviations in Table 2 are described below.
BDMPA: 3-butoxy-N,N-dimethylpropanamide

TABLE 2
Compositions and physical properties of polymers obtained in Synthesis Examples 4 to 8

| | | Synthesis | Synthesis | Synthesis | Synthesis | Synthesis |
|---|---|---|---|---|---|---|
| | | Example 4 | Example 5 | Example 6 | Example 7 | Example 8 |
| Polymeric dispersant solution | | AB-1 | AB-2 | AB-3 | AB-4 | AB-5 |
| Solvent | MDMPA | 255.4 | 250.0 | — | 255.2 | 501.6 |
| | BDMPA | — | | 255.4 | — | — |
| Polymerization | Iodine | 1.0 | 0.5 | 1.0 | 1.0 | 1.0 |
| initiator | V-70 | 3.7 | 1.4 | 3.7 | 3.7 | 3.7 |
| Catalyst | DPM | 0.2 | 0.1 | 0.2 | 0.2 | 0.2 |
| Monomer for | AN | 106.1 | 106.1 | 106.1 | 92.8 | 238.7 |
| chain A | MAA | 26.5 | 26.5 | 26.5 | 39.7 | 26.5 |
| Chain A | Composition | AN/MAA | AN/MAA | AN/MAA | AN/MAA | AN/MAA |
| | Composition ratio | 80/20 | 80/20 | 80/20 | 70/30 | 90/10 |
| | (mass ratio) | | | | | |
| | Mn | 14,800 | 28,100 | 14,500 | 13,500 | 31,000 |
| | PDI | 1.41 | 1.46 | 1.39 | 1.44 | 1.45 |
| | PT | 20,700 | 40,600 | 19,800 | 22,100 | 42,500 |
| Monomer for | AN | 30 | 30 | 20 | 15 | 15 |
| chain B | MAA | 31.8 | 31.8 | 10.9 | 46.8 | 46.8 |
| Solvent | MDMPA | 216.9 | 215.5 | — | 216.8 | 268.6 |
| | BDMPA | — | — | 141.3 | — | — |
| Polymerization | V-70 | 3.1 | 3.1 | 1.6 | 3.1 | 3.1 |
| initiator | | | | | | |
| Chain B | Composition | AN/MAA | AN/MAA | AN/MAA | AN/MAA | AN/MAA |
| | Composition ratio | 48.5/51.5 | 48.5/51.5 | 64.7/35.3 | 24.2/75.8 | 24.2/75.8 |
| | (mass ratio) | | | | | |
| | Mn | 6,800 | 10,300 | 3,400 | 9,900 | 4,600 |
| | PT | 12,000 | 17,600 | 5,800 | 12,600 | 13,200 |
| A-B block | Composition | (AN/MAA)- | (AN/MAA)- | (AN/MAA)- | (AN/MAA)- | (AN/MAA)- |
| copolymer | | b-(AN/MAA) | b-(AN/MAA) | b-(AN/MAA) | b-(AN/MAA) | b-(AN/MAA) |
| (before | Composition ratio | (54.6/13.6)- | (54.6/13.6)- | (54.6/13.6)- | (47.8/20.4)- | (73.0/8.1)- |
| neutralization) | (mass ratio) | b-(15.4/16.4) | b-(15.4/16.4) | b-(20.6/11.2) | b-(7.7/24.1) | b-(4.6/14.3) |
| | Mn | 21,600 | 38,400 | 17,900 | 23,400 | 35,600 |
| | PDI | 1.52 | 1.53 | 1.4 | 1.49 | 1.65 |
| | PT | 32,700 | 58,200 | 25,600 | 34,700 | 55,700 |
| | Solid content (%) | 29.9 | 29.7 | 29.8 | 29.5 | 29.6 |
| Aqueous alkali | NaOH | 29.8 (110 | 29.8 (110 | 24.7 (110 | — | — |
| solution | | mol % | mol % | mol % | | |
| | | neutralization) | neutralization) | neutralization) | | |
| | KOH | — | — | — | 56.4 (70 | — |
| | | | | | mol % | |
| | | | | | neutralization) | |
| | LiOH•H₂O | — | — | — | — | 35.8 (100 |
| | | | | | | mol % |
| | | | | | | neutralization) |
| | Ion-exchanged water | 105.1 | 103.2 | 94.2 | 95.4 | 199.0 |
| After | Solid content (%) | 25.1 | 24.8 | 24.9 | 25.0 | 24.7 |
| neutralization | | | | | | |

### Comparative Synthesis Example 1

In a reaction container, 233.3 parts of NMP was placed and stirred, and the temperature was increased to 70° C. In a beaker, 70.0 parts of methyl methacrylate (MMA), 30.0 parts of AA, and 5.0 parts of V-65 were placed, and V-65 was completely dissolved to prepare a monomer solution. The prepared monomer solution was placed in a dropping funnel, and when the temperature in the reaction container reached 70° C., ⅓ of the total amount was put into the reaction container, and the remaining solution was dropped over 1.5 hours. V-65 in an amount of 1.0 part was added 2.5 hours after completion of the dropping. After the temperature of the resulting mixture was kept at 70° C. for 1 hour, the temperature was increased to 80° C. and kept there for 2 hours to form a polymer. After the reaction solution was cooled, the solid content was measured to ascertain that almost all the monomers were consumed. Mn and PDI of the polymer were 21,900 and 2.21 respectively.

In a beaker, 18.3 parts (110 mol % based on AA) of NaOH and 83.2 parts of ion-exchanged water were placed, and NaOH was completely dissolved to prepare an aqueous NaOH solution. After the temperature in the reaction container became 60° C. or lower, the aqueous NaOH solution was put into the reaction container to neutralize carboxy groups, and thus polymeric dispersant solution AH-1 was obtained. The solid content of polymeric dispersant solution AH-1 obtained was 23.0%.

### Comparative Synthesis Example 2

In a reaction container, 233.3 parts of NMP was placed and stirred, and the temperature was increased to 70° C. In a beaker, 85.0 parts of MMA, 15.0 parts of AA, and 5.0 parts of V-65 were placed, and V-65 was completely dissolved to prepare a monomer solution. The prepared monomer solution was placed in a dropping funnel, and when the temperature in the reaction container reached 70° C., ⅓ of the total amount was put into the reaction container, and the remaining solution was dropped over 1.5 hours. V-65 in an amount of 1.0 part was added 2.5 hours after completion of the dropping. After the temperature of the resulting mixture was kept at 70° C. for 1 hour, the temperature was increased to 80° C. and kept there for 2 hours to form a polymer. After the reaction solution was cooled, the solid content was measured to ascertain that almost all the monomers were consumed. Mn and PDI of the polymer were 22,400 and 2.02 respectively.

In a beaker, 9.2 parts (110 mol % based on AA) of NaOH and 92.4 parts of ion-exchanged water were placed, and NaOH was completely dissolved to prepare an aqueous NaOH solution. After the temperature in the reaction container became 60° C. or lower, the aqueous NaOH solution was put into the reaction container. However, the polymer was precipitated, and therefore an aqueous solution was not able to be prepared.

### Comparative Synthesis Example 3

In a reaction container, 400.0 parts of NMP was placed and stirred, and the temperature was increased to 70° C. In a beaker, 40.0 parts of AN, 60.0 parts of AA, and 5.0 parts of V-65 were placed, and V-65 was completely dissolved to prepare a monomer solution. The prepared monomer solution was placed in a dropping funnel, and when the temperature in the reaction container reached 70° C., ⅓ of the total amount was put into the reaction container, and the remaining solution was dropped over 1.5 hours. V-65 in an amount of 1.0 part was added 2.5 hours after completion of the dropping. After the temperature of the resulting mixture was kept at 70° C. for 1 hour, the temperature was increased to 80° C. and kept there for 2 hours to form a polymer. After the reaction solution was cooled, the solid content was measured to ascertain that almost all the monomers were consumed. Mn and PDI of the polymer were 19,300 and 2.42 respectively.

In a beaker, 46.7 parts (100 mol % based on AA) of potassium hydroxide (KOH) and 120.0 parts of ion-exchanged water were placed, and KOH was completely dissolved to prepare an aqueous KOH solution. After the temperature in the reaction container became 60° C. or lower, the aqueous KOH solution was put into the reaction container to neutralize carboxy groups, and thus polymeric dispersant solution AH-2 was obtained. The solid content of polymeric dispersant solution AH-2 obtained was 15.1%.

### <Preparation of Carbon Nanotube (CNT) Dispersion>

### Example 1

In a resin container, 1.0 part of a multi-walled carbon nanotube (trade name “K-nanos 100T,” manufactured by KUMHO, average diameter: 11 to 13 nm, average length: 40 to 50 m)(100T), 94.69 parts of water, 4.31 parts of polymeric dispersant solution AA-1 (solid content 23.2%), and 180 parts of zirconia beads (diameter 0.8 mm$) were placed. CNT was wet but settled on the bottom of the container, and there was a transparent layer at the upper part of the container. The liquid was subjected to dispersion treatment for 60 minutes using Skandex, and the liquid became uniformly black, indicating that the aggregates of CNT were broken up. Subsequently, the liquid was subjected to centrifugal separation treatment to separate insufficiently dispersed CNT by sedimentation, and the supernatant was taken out as CNT dispersion-1.

### Examples 2 to 18 and Comparative Examples 1 to 4

CNT dispersions-2 to 22 were prepared in the same manner as in Example 1 except that the combinations shown in Table 3 were adopted. The meanings of the abbreviations in Table 3 are described below.
MWCNT: (manufactured by Hamamatsu Carbonics Corporation, multi-walled carbon nanotube, average diameter: 10 to 40 nm, average length: 1,000 μm±500 μm)
SG101: (trade name “SG101,” manufactured by Zeon Corporation, single-walled carbon nanotube, average diameter: 3 to 5 nm, average length: 100 to 600 m)
Tuball: (manufactured by OCSiAl, single-walled carbon nanotube, average diameter: 1.6±0.4 nm, average length: 5 μm)

TABLE 3
Preparation of CNT dispersion

| | | | | Polymeric dispersant solution | | | | |
|---|---|---|---|---|---|---|---|---|
| | | | | | | Amount | | |
| | | | | | | (parts) | | |
| | | | | | | of polymeric | | |
| | | | | | | dispersant | | |
| | | CNT | | | | based on | | |
| | CNT | | Amount | | Amount | 100 parts | Water | Total |
| | dispersion | Type | (parts) | Type | (parts) | of CNT | (parts) | (parts) |
| Example 1 | −1 | 100T | 1 | AA-1 | 4.31 | 100 | 94.69 | 100 |
| Example 2 | −2 | 100T | 1 | AA-2 | 4.52 | 100 | 94.48 | 100 |
| Example 3 | −3 | 100T | 1 | AA-3 | 3.91 | 100 | 95.09 | 100 |
| Example 4 | −4 | 100T | 1 | AB-1 | 3.98 | 100 | 95.02 | 100 |
| Example 5 | −5 | 100T | 1 | AB-2 | 4.03 | 100 | 94.97 | 100 |
| Example 6 | −6 | 100T | 1 | AB-3 | 4.02 | 100 | 94.98 | 100 |
| Example 7 | −7 | 100T | 1 | AB-4 | 4.00 | 100 | 95.00 | 100 |
| Example 8 | −8 | 100T | 1 | AB-5 | 4.05 | 100 | 94.95 | 100 |
| Example 9 | −9 | MWCNT | 1 | AB-1 | 3.98 | 100 | 95.02 | 100 |
| Example 10 | −10 | SG101 | 0.4 | AA-1 | 4.31 | 250 | 95.29 | 100 |
| Example 11 | −11 | SG101 | 0.4 | AA-2 | 4.52 | 250 | 95.08 | 100 |
| Example 12 | −12 | SG101 | 0.4 | AA-3 | 3.91 | 250 | 95.69 | 100 |
| Example 13 | −13 | SG101 | 0.4 | AB-1 | 3.98 | 250 | 95.62 | 100 |
| Example 14 | −14 | SG101 | 0.4 | AB-2 | 4.03 | 250 | 95.57 | 100 |
| Example 15 | −15 | SG101 | 0.4 | AB-3 | 4.02 | 250 | 95.58 | 100 |
| Example 16 | −16 | SG101 | 0.4 | AB-4 | 4.00 | 250 | 95.6 | 100 |
| Example 17 | −17 | SG101 | 0.4 | AB-5 | 4.05 | 250 | 95.55 | 100 |
| Example 18 | −18 | Tuball | 0.4 | AB-1 | 3.98 | 250 | 95.62 | 100 |
| Comparative | −19 | 100T | 1 | AH-1 | 4.35 | 100 | 94.65 | 100 |
| Example 1 | | | | | | | | |
| Comparative | −20 | 100T | 1 | AH-2 | 6.62 | 100 | 92.38 | 100 |
| Example 2 | | | | | | | | |
| Comparative | −21 | SG101 | 0.4 | AH-1 | 4.35 | 250 | 95.25 | 100 |
| Example 3 | | | | | | | | |
| Comparative | −22 | SG101 | 0.4 | AH-2 | 6.62 | 250 | 92.98 | 100 |
| Example 4 | | | | | | | | |

### <Evaluation of CNT Dispersion>

The viscosity at 25° C. was measured for each CNT dispersion immediately after dispersion (initial) and after being left to stand still for 10 days using an E-type viscometer (measurement conditions: 25° C. and a rotor revolution rate of 100 rpm). The change rate of viscosity after the CNT dispersion was left to stand still for 10 days based on the initial viscosity (viscosity change rate (%)) was calculated to evaluate the viscosity stability of the CNT dispersion according to the evaluation criteria described below. Furthermore, the state of the CNT dispersion after being left to stand still for 10 days was observed with an optical microscope (200×) to check whether an aggregate was present or not.
Excellent: the viscosity change rate is less than 5%.
Good: the viscosity change rate is 5% or more and less than 10%.
Poor: the viscosity change rate is 10% or more.

In addition, the CNT concentration of the CNT dispersion after the centrifugal separation was measured. A spectrophotometer was used for the measurement of the CNT concentration. Specifically, the absorbance was measured for samples in which the CNT concentration was known to make a calibration curve. The absorbance of a sample obtained by diluting the CNT dispersion to a concentration where the absorbance was able to be measured was measured to calculate the CNT concentration of the sample from the calibration curve. The ratio (%) of the CNT concentration after the centrifugal separation to the CNT concentration designed was calculated as “dispersion stability (%).” When the dispersion stability is closer to 100%, it means that the dispersibility of CNT is better. The results of evaluation of the CNT dispersion are shown in Table 4.

TABLE 4
Results of evaluation of CNT dispersion

| | | | | Viscosity | | | | |
|---|---|---|---|---|---|---|---|---|
| | | | | (mPa · s) | | | | |
| | | | | after | | | | State |
| | | | | being left | | CNT | | after being |
| | | | | to stand | | concentration | | left to |
| | | CNT | Initial | still | | (%) after | Dispersion | stand still |
| | CNT | concentration | viscosity | for | Viscosity | centrifugal | stability | for |
| | dispersion | (%) | (mPa · s) | 10 days | stability | separation | (%) | 10 days |
| Example 1 | −1 | 1 | 2.98 | 2.99 | Excellent | 0.99 | 99.0 | No aggregate |
| Example 2 | −2 | 1 | 2.83 | 2.84 | Excellent | 0.99 | 99.0 | No aggregate |
| Example 3 | −3 | 1 | 3.45 | 3.46 | Excellent | 0.98 | 98.0 | No aggregate |
| Example 4 | −4 | 1 | 2.78 | 2.77 | Excellent | 0.99 | 99.0 | No aggregate |
| Example 5 | −5 | 1 | 2.86 | 2.91 | Excellent | 0.98 | 98.0 | No aggregate |
| Example 6 | −6 | 1 | 2.99 | 3.01 | Excellent | 0.97 | 97.0 | No aggregate |
| Example 7 | −7 | 1 | 2.75 | 2.72 | Excellent | 0.99 | 99.0 | No aggregate |
| Example 8 | −8 | 1 | 3.21 | 3.15 | Excellent | 0.98 | 98.0 | No aggregate |
| Example 9 | −9 | 1 | 2.85 | 2.83 | Excellent | 0.98 | 98.0 | No aggregate |
| Example 10 | −10 | 0.4 | 15.6 | 15.7 | Excellent | 0.39 | 97.5 | No aggregate |
| Example 11 | −11 | 0.4 | 18.4 | 18.9 | Excellent | 0.39 | 97.5 | No aggregate |
| Example 12 | −12 | 0.4 | 16.2 | 16.3 | Excellent | 0.39 | 97.5 | No aggregate |
| Example 13 | −13 | 0.4 | 20.3 | 20.5 | Excellent | 0.39 | 97.5 | No aggregate |
| Example 14 | −14 | 0.4 | 21.4 | 21.7 | Excellent | 0.39 | 97.5 | No aggregate |
| Example 15 | −15 | 0.4 | 31.6 | 31.8 | Excellent | 0.39 | 97.5 | No aggregate |
| Example 16 | −16 | 0.4 | 30.9 | 31.1 | Excellent | 0.38 | 95.0 | No aggregate |
| Example 17 | −17 | 0.4 | 28.4 | 28.6 | Excellent | 0.39 | 97.5 | No aggregate |
| Example 18 | −18 | 0.4 | 18.1 | 18.3 | Excellent | 0.39 | 97.5 | No aggregate |
| Comparative | −19 | 1 | 120.2 | 150.4 | Poor | 0.70 | 70.0 | Aggregate |
| Example 1 | | | | | | | | present |
| Comparative | −20 | 1 | 45.1 | 49.1 | Good | 0.82 | 82.0 | Aggregate |
| Example 2 | | | | | | | | present |
| Comparative | −21 | 0.4 | 325.4 | 423.6 | Poor | 0.22 | 55.0 | Aggregate |
| Example 3 | | | | | | | | present |
| Comparative | −22 | 0.4 | 287.1 | 347.7 | Poor | 0.21 | 52.5 | Aggregate |
| Example 4 | | | | | | | | present |

### <Preparation of Carbon Black (CB) Dispersion>

### Example 19

In a resin container, 3.0 parts of carbon black (trade name “Li-435,” manufactured by Denka Company Limited, acetylene black) (CB), 84.07 parts of water, 12.93 parts of polymeric dispersant solution AA-1 (solid content 23.2%), and 180 parts of zirconia beads (diameter 0.8 mm$) were placed. CB was wet but settled on the bottom of the container, and there was a transparent layer at the upper part of the container. The liquid was subjected to dispersion treatment for 60 minutes using Skandex, and the liquid became uniformly black, indicating that the aggregates of CB were broken up. Subsequently, the liquid was subjected to centrifugal separation treatment to separate insufficiently dispersed CB by sedimentation, and the supernatant was taken out as CB dispersion-1.

### Examples 20 to 26 and Comparative Examples 5 and 6

CB dispersions-2 to 10 were prepared in the same manner as in Example 19 except that the combinations shown in Table 5 were adopted.

TABLE 5
Preparation of CB dispersion

| | | | Polymeric dispersant solution | | | | |
|---|---|---|---|---|---|---|---|
| | | | | | Amount | | |
| | | | | | (parts) of | | |
| | | | | | polymeric | | |
| | | | | | dispersant | | |
| | | | | | based on | | |
| | CB | CB | | Amount | 100 parts | Water | Total |
| | dispersion | (parts) | Type | (parts) | of CB | (parts) | (parts) |
| Example 19 | −1 | 3 | AA-1 | 12.93 | 100 | 84.07 | 100 |
| Example 20 | −2 | 3 | AA-2 | 13.57 | 100 | 83.43 | 100 |
| Example 21 | −3 | 3 | AA-3 | 11.72 | 100 | 85.28 | 100 |
| Example 22 | −4 | 3 | AB-1 | 11.95 | 100 | 85.05 | 100 |
| Example 23 | −5 | 3 | AB-2 | 12.10 | 100 | 84.90 | 100 |
| Example 24 | −6 | 3 | AB-3 | 12.05 | 100 | 84.95 | 100 |
| Example 25 | −7 | 3 | AB-4 | 12.00 | 100 | 85.00 | 100 |
| Example 26 | −8 | 3 | AB-5 | 12.15 | 100 | 84.85 | 100 |
| Comparative | −9 | 3 | AH-1 | 13.04 | 100 | 83.96 | 100 |
| Example 5 | | | | | | | |
| Comparative | −10 | 3 | AH-2 | 19.87 | 100 | 77.13 | 100 |
| Example 6 | | | | | | | |

### <Evaluation of CB Dispersion>

The viscosity at 25° C. was measured for each CB dispersion immediately after dispersion (initial) and after being left to stand still for 10 days using an E-type viscometer (measurement conditions: 25° C. and a rotor revolution rate of 100 rpm). The change rate of viscosity after the CB dispersion was left to stand still for 10 days based on the initial viscosity (viscosity change rate (%)) was calculated to evaluate the viscosity stability of the CB dispersion according to the evaluation criteria described below.
Excellent: the viscosity change rate is less than 5%.
Good: the viscosity change rate is 5% or more and less than 10%.
Poor: the viscosity change rate is 10% or more.

Furthermore, the state of the CB dispersion after being left to stand still for 10 days was observed with an optical microscope (200×) to check whether an aggregate was present or not. The results of evaluation of the CB dispersion are shown in Table 6.

TABLE 6
Results of evaluation of CB dispersion

| | | | Viscosity (mPa · s) | | State after |
|---|---|---|---|---|---|
| | | Initial | after being left | | being left |
| | CB | viscosity | to stand still | Viscosity | to stand still |
| | dispersion | (mPa · s) | for 10 days | stability | for 10 days |
| Example 19 | −1 | 2.06 | 2.06 | Excellent | No aggregate |
| Example 20 | −2 | 2.13 | 2.13 | Excellent | No aggregate |
| Example 21 | −3 | 2.21 | 2.22 | Excellent | No aggregate |
| Example 22 | −4 | 2.58 | 2.59 | Excellent | No aggregate |
| Example 23 | −5 | 3.46 | 3.45 | Excellent | No aggregate |
| Example 24 | −6 | 4.37 | 4.37 | Excellent | No aggregate |
| Example 25 | −7 | 3.64 | 3.65 | Excellent | No aggregate |
| Example 26 | −8 | 3.82 | 3.81 | Excellent | No aggregate |
| Comparative | −9 | 4.65 | 6.41 | Poor | Aggregate |
| Example 5 | | | | | present |
| Comparative | −10 | 8.64 | 25.7 | Poor | Aggregate |
| Example 6 | | | | | present |

### <Preparation of CNT Dispersion Containing Bider>

### Examples 27 to 29 and Comparative Examples 7 to 8

CNT dispersions B-1 to 5 containing a binder were obtained by blending the type of CNT dispersion, shown as “CNT dispersion used as raw material” shown in Table 7 and a binder (styrene/acrylic resin, trade name “YL-1098,” manufactured by Seiko PMC Corporation) in a ratio such that the concentration of the carbon material (CNT) in the coating film (solid content) to be formed was 3%, and then mixing the resulting mixture using a magnetic stirrer.

### <Evaluation of CNT Dispersion Containing Binder>

The viscosity at 25° C. was measured for each CNT dispersion immediately after dispersion (initial) and after being left to stand still for 10 days using an E-type viscometer (measurement conditions: 25° C. and a rotor revolution rate of 100 rpm). The change rate of viscosity after the CNT dispersion was left to stand still for 10 days based on the initial viscosity (viscosity change rate (%)) was calculated to evaluate the viscosity stability of the CNT dispersion according to the evaluation criteria described below. Furthermore, the state of the CNT dispersion after being left to stand still for 10 days was observed with an optical microscope (200×) to check whether an aggregate was present or not. The results are shown in Table 7.
Excellent: the viscosity change rate is less than 5%.
Good: the viscosity change rate is 5% or more and less than 10%.
Poor: the viscosity change rate is 10% or more.

In addition, a blank solution having the same composition as that of the dispersion except that the carbon material was not contained was prepared. After a base line was measured using the prepared blank solution, the absorbance of the sample solution was measured. The absorbance of the sample solution was measured using a spectrophotometer (trade name “Hitachi Spectrophotometer U-3310,” manufactured by Hitachi High-Tech Science Corporation) equipped including a quartz cell having an optical path length of 10 mm. As for dilution with the blank solution, a calibration curve is created by plotting the absorbance at a wavelength of 580 nm against changes in dilution ratio to calculate a dilution ratio where the absorbance is 1.8±0.02, and a dispersion diluted to an intended concentration was prepared. In addition, it is also possible to perform dispersion after adjusting the carbon constituent concentration as intended at a stage before dispersing the carbon material or after adjusting the carbon constituent concentration so as to satisfy the above-described absorbance at an initial blending stage. The specific method for preparing the sample solution was as follows: first, the dispersion was taken in a polyethylene bottle, and an appropriate amount of the blank solution was added based on the dilution ratio determined from the calibration curve; and the resulting mixture was stirred for 30 seconds using Vortex Mixer (manufactured by Scientific Industries, Inc.) to obtain the sample solution such that absorbance A₅₈₀ at a wavelength of 580 nm was 1.8±0.02. Absorbance A₃₈₀ at a wavelength of 380 nm and absorbance A₇₈₀ at a wavelength of 780 nm of the obtained sample solution were measured and an absorbance ratio (A₃₈₀/A₇₈₀) was calculated.

### <Evaluation of Coating Film>

The CNT dispersion was applied on a PET film with a thickness of 100 μm (trade name “Lumirror,” manufactured by Toray Industries, Inc.) using a bar coater and then dried in an electric oven set at 90° C. for 30 minutes to remove volatile components, and thus a coating film having a film thickness of 1 μm was formed. The result of measurement of the surface resistivity of the formed coating film is shown in Table 7. When the surface resistivity was higher than 10⁵ Ω/sq, a resistivity meter for a high resistivity range (trade name “Hiresta-UP MCP-HT450,” manufactured by Nittoseiko Analytech Co., Ltd.) was used to calculate the average value of the surface resistivity of the coating film measured at 5 points with an applied voltage of 10 V. When the surface resistivity was 10⁵ Ω/sq or lower, a resistivity meter for a low resistivity range (trade name “Loresta-GP MCP-T610,” manufactured by Nittoseiko Analytech Co., Ltd.) was used to calculate the average value of the surface resistivity of the coating film measured at 5 points with an applied voltage of 10 V.

TABLE 7
Results of evaluation of CNT dispersion (containing binder)

| | | | | Viscosity | | | | |
|---|---|---|---|---|---|---|---|---|
| | | | | (mPa · s) | | State | | |
| | | CNT | | after being | | after | | |
| | | dispersion | | left | | being left | | |
| | | used as | Initial | to stand | | to stand | Absorbance | Surface |
| | CNT | raw | viscosity | still for | Viscosity | still for | ratio | resistivity |
| | dispersion | material | (mPa · s) | 10 days | stability | 10 days | (A₃₈₀/A₇₈₀) | (Ω/sq) |
| Example 27 | B-1 | −4 | 3.77 | 3.69 | Excellent | No | 1.812 | 5.2 × 10⁴ |
| | | | | | | aggregate | | |
| Example 28 | B-2 | −9 | 3.89 | 3.76 | Excellent | No | 1.545 | 2.0 × 10⁴ |
| | | | | | | aggregate | | |
| Example 29 | B-3 | −13 | 28.4 | 27.4 | Excellent | No | 1.744 | 2.1 × 10⁶ |
| | | | | | | aggregate | | |
| Comparative | B-4 | −19 | 122.3 | 161.1 | Poor | Aggregate | 1.411 | 1.1 × 10⁸ |
| Example 7 | | | | | | present | | |
| Comparative | B-5 | −21 | 341.9 | 474.7 | Poor | Aggregate | 1.338 | 7.9 × 10⁹ |
| Example 8 | | | | | | present | | |

### Application Examples

### (Application Example 1: Battery Material (Negative Electrode))

The following materials were used in producing a negative electrode of a lithium-ion battery.

### [Negative Electrode Active Material]

Graphene (manufactured by FUJIFILM Wako Pure Chemical Corporation)
Silicon monoxide (manufactured by FUJIFILM Wako Pure Chemical Corporation)

### [Binder]

10% Aqueous polyacrylic acid solution (trade name “CLPA-C07,” manufactured by FUJIFILM Wako Pure Chemical Corporation)
Carboxymethyl cellulose (trade name “CMC Daicel 2200,” manufactured by Daicel Miraizu Ltd.)
Styrene/butadiene copolymer latex (trade name “SR-112,” manufactured by NIPPON A&L INC.)

A negative electrode material was obtained by mixing 15 parts of silicon monoxide, 85 parts of graphene, 3 parts of the dispersion produced in Example 4, 30 parts of the 10% aqueous polyacrylic acid solution, 21.6 parts of carboxymethyl cellulose, and 0.4 parts of the styrene/butadiene copolymer latex using a planetary mixer. Note that another mixing apparatus, such as a rotating/revolving mixer, may be used for mixing. The negative electrode material was applied on a copper foil with a thickness of 20 μm using an applicator such that the weight per unit area after drying was 15 mg/cm². The applied negative electrode material was placed in an oven set at 120° C. for 30 minutes for drying, and then the copper foil was rolled with a roll press to obtain a negative electrode. The obtained negative electrode had a volume resistivity of 0.18 Ω·cm.

### (Application Example 2: Battery Material (Negative Electrode))

A negative electrode was produced in the same manner as in Application Example 1 except that the dispersion produced in Example 13 was used. The produced negative electrode had a volume resistivity of 0.16 Ω·cm.

### (Application Example 3: Battery Material (Negative Electrode))

A negative electrode was produced in the same manner as in Application Example 1 except that the dispersion produced in Comparative Example 2 was used. The produced negative electrode had a volume resistivity of 0.49 Ω·cm. It was found from those described above that the use of a dispersion for which evaluation of dispersibility is good makes it possible to produce a negative electrode exhibiting a smaller volume resistivity value.

### (Application Example 4: Battery Material (Negative Electrode))

A negative electrode material was obtained by mixing 15 parts of silicon monoxide, 85 parts of graphene, 3 parts of the dispersion produced in Example 13, and 32 parts of the 10% aqueous polyacrylic acid solution using a planetary mixer. The negative electrode material was applied on a copper foil with a thickness of 20 μm using an applicator such that the weight per unit area after drying was 15 mg/cm². The applied negative electrode material was placed in an oven set at 120° C. for 30 minutes for drying, and then the copper foil was rolled with a roll press to obtain a negative electrode. The obtained negative electrode had a volume resistivity of 0.15 Ω·cm. It was found from those described above that unification of the binder and the dispersant into the (meth)acrylic resin makes it possible to produce a negative electrode exhibiting a smaller volume resistivity value.

### INDUSTRIAL APPLICABILITY

The carbon material dispersion of the present invention is not only useful as a constituent material for aqueous paints, aqueous inks, plastic shaped articles, and the like which exhibit characteristics such as, for example, high electrical conductivity and high thermal conductivity but also suitable for various applications such as battery materials, electronic component trays, IC chip covers, electromagnetic wave shields, automobile members, and robot components.

1. A carbon material dispersion comprising:
at least one carbon material selected from the group consisting of carbon black, carbon fibers, carbon nanotubes, graphite, and graphene;
water; and
a polymeric dispersant, wherein
the polymeric dispersant is a polymer having carboxy groups at least part of which are neutralized with an alkali, the polymer composed of 50 to 80% by mass of a constituent unit (1) derived from (meth)acrylonitrile and 20 to 50% by mass of a constituent unit (2) derived from (meth)acrylic acid, provided that the total amount of the constituent unit (1) and the constituent unit (2) is 100% by mass,
the polymer has a number average molecular weight of 10,000 to 50,000,
the polymer is an A-B block copolymer comprising:
a polymer block A composed of 70 to 90% by mass of a constituent unit (1-A) derived from acrylonitrile and 10 to 30% by mass of a constituent unit (2-A) derived from methacrylic acid, provided that the total amount of the constituent unit (1-A) and the constituent unit (2-A) is 100% by mass; and
a polymer block B composed of 10 to 70% by mass of a constituent unit (1-B) derived from acrylonitrile and 30 to 90% by mass of a constituent unit (2-B) derived from methacrylic acid, provided that the total amount of the constituent unit (1-B) and the constituent unit (2-B) is 100% by mass,
the polymer block A has a number average molecular weight of 8,000 to 40,000 and a polydispersity index of 1.8 or less, and
the content of carboxy groups in the polymer block A is smaller than the content of carboxy groups in the polymer block B.

2. The carbon material dispersion according to claim 1, wherein
the alkali is at least one selected from the group consisting of lithium hydroxide, sodium hydroxide, and potassium hydroxide, and
the amount of the alkali corresponds to 50 to 120 mol % of the carboxy groups.

3. The carbon material dispersion according to claim 1, further comprising at least one water-soluble organic solvent selected from the group consisting of dimethylformamide, dimethylacetamide, diethylacetamide, N-methylpyrrolidone, 3-methoxy-N,N-dimethylpropanamide, 3-butoxy-N,N-dimethylpropanamide, tetramethyl urea, 1,3-dimethylimidazolidinone, and acetonitrile.

4. The carbon material dispersion according to claim 1, wherein
the content of the polymeric dispersant based on 100 parts by mass of the carbon material is 10 to 350 parts by mass, and
the content of the carbon material is 15% by mass or less.

5. The carbon material dispersion according to claim 1 further comprising a binder resin.

6. Use of the carbon material dispersion according to claim 1 for producing any one of the products of paints, inks, coating agents, materials for resin shaped articles, electrically conductive materials, thermally conductive materials, and antistatic materials.

7. Use of the carbon material dispersion according to claim 1 for producing any one of the products of battery materials and mechanical components each comprising a film formed with the carbon material dispersion.
